(19) United States
(12) Patent Application Publication
(10) Pub. No.: US 2018/0129067 A1
(43) Pub. Date: May 10, 2018

(54) TECHNICAL EYEWEAR

(71) Applicants: Barron Boedecker, Los Angeles, CA (US); Matt Cutshall, Los Angeles, CA (US)

(72) Inventors: Barron Boedecker, Los Angeles, CA (US); Matt Cutshall, Los Angeles, CA (US)

(21) Appl. No.: 15/868,827

(22) Filed: Jan. 11, 2018

Related U.S. Application Data
(63) Continuation-in-part of application No. 15/354,386, filed on Nov. 17, 2016.
(60) Provisional application No. 62/394,878, filed on Sep. 15, 2016.

(51) Int. Cl. G02C 5/00; G02C 11/00; G02C 5/14; A45C 13/10

(52) U.S. Cl. CPC G02C 5/008; A45C 13/1069; G02C 5/14; G02C 11/00

(57) ABSTRACT

An eyeglasses frame including: a frame body, a first temple, a second temple, a first magnet, and a second magnet. The frame body is for supporting a pair of lenses. The first temple is pivotally coupled with the frame body about a first hinge and includes a first earpiece. The second temple is pivotally coupled with the frame body about a second hinge and includes a second earpiece. The first magnet is positioned at least partially within the first temple between the first hinge and the first earpiece. The second magnet is positioned at least partially within the second temple between the second hinge and the second earpiece. The first magnet and the second magnet are configured to be positioned adjacent each other and exert a closing force relative to each other when the first and second temples are pivoted, respectively, about the first and second hinges.

### CROSS-REFERENCE TO RELATED APPLICATION

The present application is a continuation-in-part application of U.S. patent application Ser. No. 15/354,386, entitled “EYEGLASSES WITH MAGNETIC COMPONENTS”, and filed Nov. 17, 2016, which application claims priority under 35 U.S.C. § 119 to U.S. Provisional Patent Application No. 62/394,878, filed Sep. 15, 2016, entitled “EYEGLASSES WITH MAGNETIC COMPONENTS”, which is hereby incorporated by reference in its entirety into the present application.

### TECHNICAL FIELD

Aspects of the present disclosure involve technical eyeglasses with magnetic components or inserts.

### BACKGROUND

Eyeglasses including sunglasses, reading glasses, and the like are worn by people all over the world and by wearers of all ages. In the case of sunglasses and reading glasses, a user may only wear them for short period of time before stowing them for use at a later time. While a case, sleeve, or pouch often accompanies the purchase of a pair of eyeglasses, it can be cumbersome and frustrating to keep the case, sleeve, or pouch with the eyeglasses at all times. Because of this, users often stow the eyeglasses in their pocket or hang the eyeglasses by one of the arms or temples in a pocket or in the neck opening of a shirt. Other stowing options include setting the eyeglasses down on a surface (e.g., counter, seat).

Each of these stowing options presents their own challenges and, too often, the eyeglasses are damaged as a result of an inadvertent fall to the ground. With these thoughts in mind, among others, aspects of the eyeglasses with magnetic components, disclosed herein, was conceived.

### SUMMARY

Aspects of the present disclosure may involve an eyeglasses frame including: a frame body, a first temple, a second temple, a first magnet, and a second magnet. The frame body is for supporting a pair of lenses. The first temple is pivotally coupled with the frame body about a first hinge and includes a first earpiece. The second temple is pivotally coupled with the frame body about a second hinge and includes a second earpiece. The first magnet is positioned at least partially within the first temple between the first hinge and the first earpiece. The second magnet is positioned at least partially within the second temple between the second hinge and the second earpiece. The first magnet and the second magnet are configured to be positioned adjacent each other and exert a closing force relative to each other when the first and second temples are pivoted, respectively, about the first and second hinges.

In certain instances, the first and second temples are molded around the first and second magnets, respectively.

In certain instances, the first and second magnets are removable from the first and second temples, respectively.

In certain instances, the first and second magnets are positioned on the first and second temples, respectively, at a point where the first and second temples overlap each other.

In certain instances, the eyeglasses frame may further include the pair of lenses supported by the frame body.

Aspects of the present disclosure may further include a kit including the eyeglasses frame and the pair of lenses, and may further include an attraction element including a ferromagnetic material.

In certain instances, the kit may further include an adhesive pad configured to adhere to the attraction element.

In certain instances, the attraction element includes a shape of a company logo or product.

Aspects of the present disclosure may further involve an eyeglasses frame including: a frame body; a first temple; a second temple; a first temple element; and a second temple element. The frame body may support a pair of lenses and may include a first frame element positioned on a first side of the frame body and a second frame element positioned on a second side of the frame body. The first temple may pivotally couple with the frame body at a first hinge, the first temple including a first earpiece. The second temple may pivotally couple with the frame body at a second hinge, the second temple including a second earpiece. The first temple element may be positioned at least partially within the first temple at the first earpiece. The second temple element may be positioned at least partially within the second temple at the second earpiece. And, when the first and second temples are pivoted about the first and second hinges, respectively, the first temple element may be configured to be positioned adjacent the first frame element and magnetically attract the first frame element, and the second temple element is configured to be positioned adjacent the second frame element and magnetically attract the second frame element.

In certain instances, the first and second frame elements are positioned within the frame body.

In certain instances, the frame body is injection molded around the first and second frame elements.

In certain instances, the first and second temples are injection molded around the first and second temple elements.

In certain instances, the first and second temple elements are magnets.

In certain instances, the first and second frame elements are ferromagnetic materials.

In certain instances, the eyeglasses frame may further include the pair of lenses.

In certain instances, the pair of lenses are sunglasses lenses.

In certain instances, the pair of lenses are prescription lenses.

Aspects of the present disclosure may also involve a method of manufacturing an eyeglasses frame including providing an eyeglasses mold including a temple mold, positioning a magnet within the temple mold, injecting a molding material into the eyeglasses mold, and removing the eyeglasses frame from the eyeglasses mold.

### BRIEF DESCRIPTION OF THE DRAWINGS

Example embodiments are illustrated in referenced figures of the drawings. It is intended that the embodiments and figures disclosed herein are to be considered illustrative rather than limiting.

FIG. 1 is an isometric back view of a pair of eyeglasses including magnetic components positioned in the temples.

FIG. 2 is an isometric back view of the eyeglasses of FIG. 1 in a closed or locked position.

FIG. 3 is an isometric view of three pairs of eyeglasses with magnetic components magnetically coupled with a refrigerator door.

FIG. 4A is an isometric view of a pair of eyeglasses with magnetic components secured to a pants pocket.

FIG. 4B is an isometric view of a pair of eyeglasses with magnetic components secured to a neck opening of a shirt.

FIG. 5 is a back view of the eyeglasses of FIG. 1 along with an attraction element (e.g., magnet, metal).

FIG. 6A is an isometric view of the attraction element secured to the dash of a car.

FIG. 6B is an isometric view of the eyeglasses of FIG. 1 magnetically coupled with the attraction element.

FIG. 7A is an isometric top view of a pair of eyeglasses with a four-hinge design with magnetic components.

FIG. 7B is an isometric side view of the pair of eyeglasses with the four-hinge design in a folded and locked state.

FIG. 8 is a back view of the eyeglasses with magnets positioned at the earpieces and a ferromagnetic material positioned within the frame.

FIG. 9 is a front isometric view of a pair of wireframe the eyeglasses with magnets positioned along the temples.

FIG. 10 is a side view of a temple with an opening and a channel for inserting and removing a magnet therein.

FIG. 11 is a cross-sectional view of a temple showing the channel with a magnet positioned therein, and being held in position via a metal tab.

FIG. 12 is a side view of a screw or bolt with at least a portion of it being a magnet.

FIG. 13 is a side view of a rivet with at least a portion of it being a magnet.

FIG. 14 is a side view of a temple with a cutout portion to show the metal insert therein.

FIG. 15 is a side view of a magnet with a semi-cylindrical indentation or bore through the magnet.

FIG. 16 is a side view of a pair of magnets, each with a semi-cylindrical indentation or bore through the magnet.

FIG. 17 is a side view of a magnet with a cylindrical bore extending therethrough.

### DETAILED DESCRIPTION

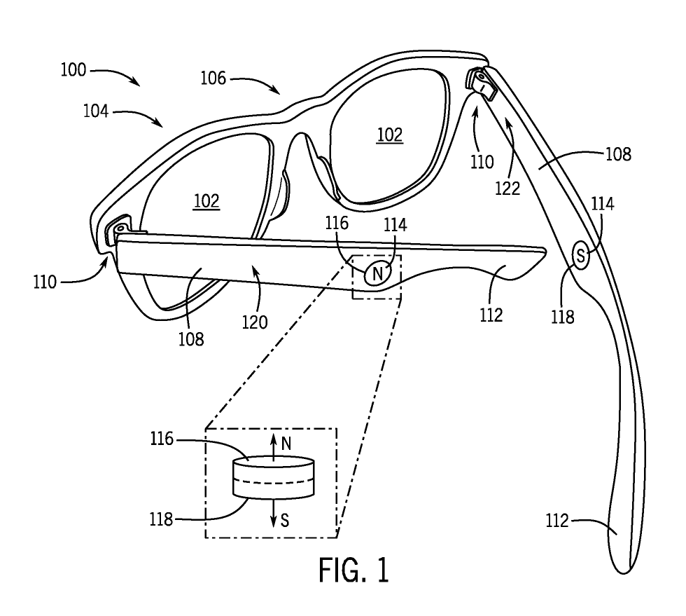

Aspects of the present disclosure involve eyeglasses (e.g., sunglasses, prescription glasses) and, more particularly, coupling the temples of the eyeglasses together so they can be secured to an object (e.g., pants pocket, shirt, attraction element). Reference is made to FIG. 1, which depicts a pair of eyeglasses 100 including a pair of lenses 102 supported in a frame or frame body 104, a bridge 106 separating the lenses 102, and a pair of temples or arms 108 pivotally coupled with the frame 104 at hinges 110. The temples 108 terminate at a temple tip or earpiece 112. As seen in the figure, a magnet 114 is positioned within or on each temple 108. The magnet 114 may be press-fit, friction-fit, interference-fit, glued, molded within, or otherwise secured within the temples 108 by any known method. More particularly, a cylinder or disc magnet 114 is positioned, fitted, or secured within a cavity or recess formed within the temples 108 of the eyeglasses 100 at a point along the temples 108 about where the temples 108 contact each other when folded about the hinges 110. In this way, the temples 108 of the eyeglasses 100 may be magnetically coupled together when the eyeglasses 100 are folded, hinged, or pivoted at the hinges 110 such that the temples 108 are resisted from unfolding or decoupling.

The magnets 114 may be axially magnetized such that a north pole 116 and a south pole 118 of the magnet 114 are directed in opposite directions. Generally speaking, opposite poles (e.g., north-to-south) of magnets 114 attract, and similar poles (e.g., north-north, south-south) of magnets 114 repel. Thus, the magnets 114 may be arranged as seen in FIG. 1, where the magnet 114 with a north pole 116 on an outer side 120 of the temple 108 will attract a south pole 118 of a magnet 114 on an inner side 122 of the opposite temple 108. Stated differently, the magnetic poles of the magnets 114 should be the same on both outer sides 120 of the temples 108, and the magnetic poles of the magnets 114 should be the same on both inner sides 122 of the temples 108. In one example, the magnets 114 are arranged with north poles 116 on the outer sides 120 of the temples 108, and south poles 118 on the inner sides 122 of the temples, as seen in FIG. 1. In another example, the eyeglasses 100 may be arranged with south poles 118 on the outer sides 120 of the temples 108 and north poles 116 on the inner sides 122 of the temples. In either example, opposite poles will attract when the temples 108 are pivoted into a closed position without regard to which temple is closer to the frame 104.

In the illustrated orientation, the temples 108 of the eyeglasses 100 can be closed in one of two orientations and the temples 108 will magnetically attract each other via the magnets 114. That is, either temple 108 may be pivoted into a closed position first.

It is noted the north and south poles 116, 118 may be referred to as a first and a second pole, where the first pole may be either the north or the south pole 116, 118, and the second pole is the opposite pole as the first pole. In certain instances, one of the magnets 114 on a temple 108 may be replaced with a ferromagnetic material such as iron or steel.

The magnets 114 may, for example, be neodymium or ceramic magnets, among others. The magnets 114 may, for example, be about 3/16 inch to about 7/16 inch in diameter and about 1/32 inch to about ⅛ inch thick. The strength of the magnets 114 may be any strength sufficient to close the temples 108 together and may have a pull force relative to each other of between about 1 pound and about 5 pounds, for example.

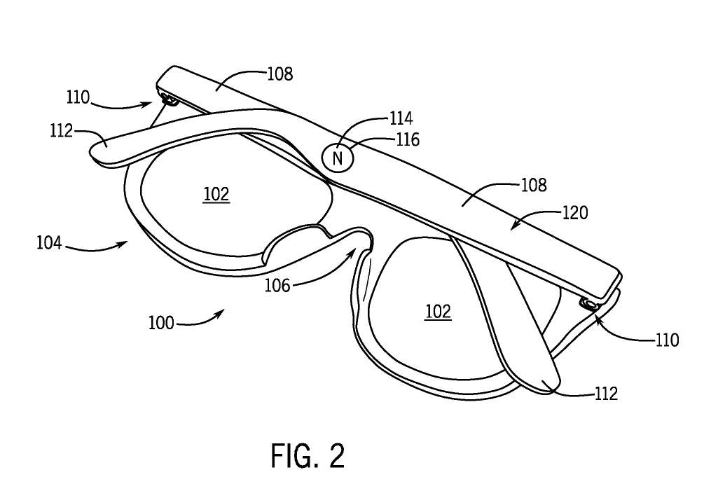

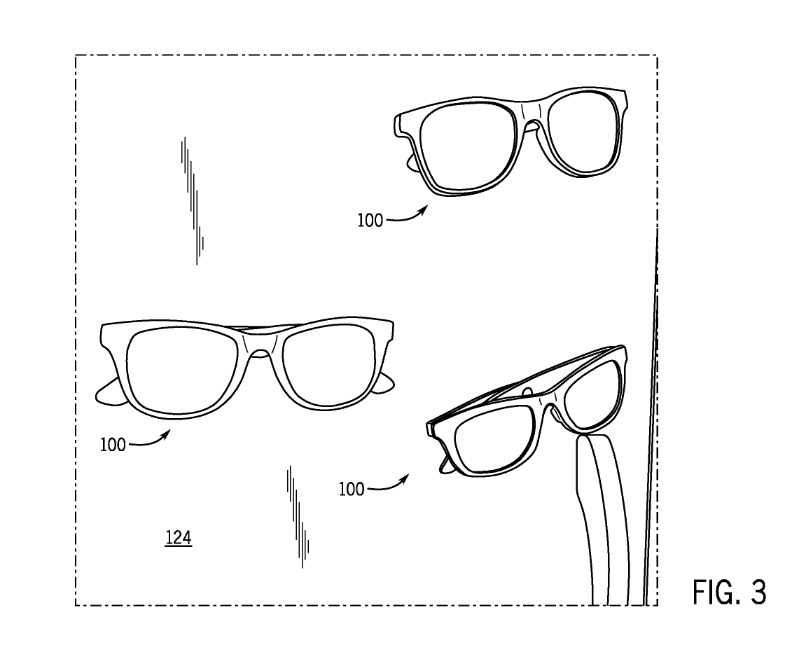

FIG. 2 depicts a pair of eyeglasses 100 in a closed or locked position or state with the magnets 114 magnetically coupled together. As seen in the figure, the north pole 116 of the magnet 114 on the outermost temple 108 is facing outward and is exposed (i.e., the south pole (not shown) of the magnet 114 is coupling with the magnet 114 from the other temple 108). Thus, the eyeglasses 100 may be magnetically coupled with a ferromagnetic material such as iron, steel, or another magnet using the exposed magnet 114. For example, as seen in FIG. 3, eyeglasses 100 in the closed position, such as the eyeglasses 100 in FIG. 2, may be magnetically coupled with a refrigerator door 124 via the exposed or outward facing magnet 114, as discussed in reference to FIG. 2.

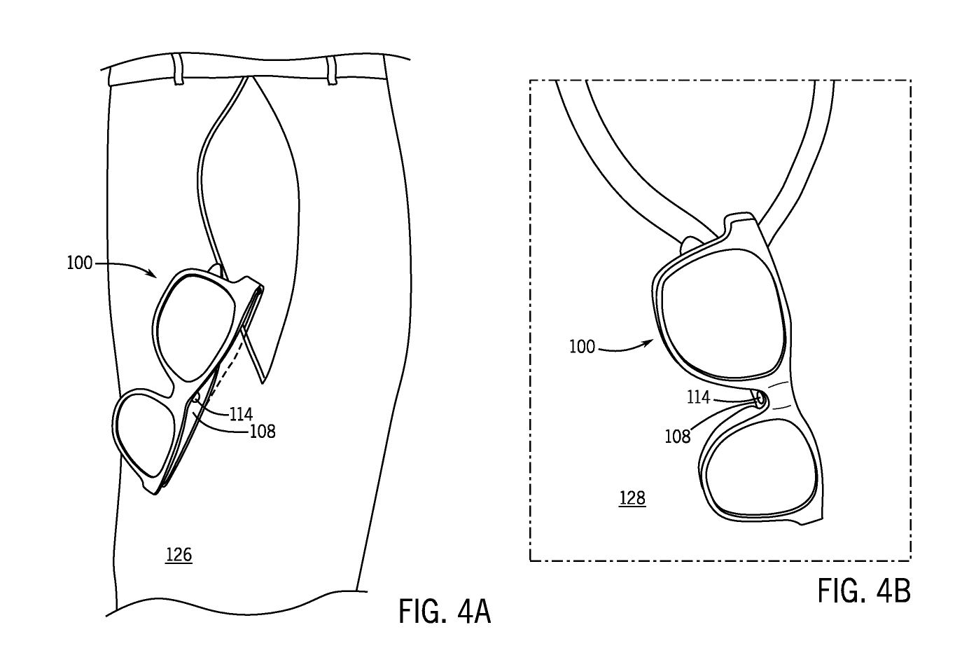

Turning to FIGS. 4A and 4B, the eyeglasses 100 may be securely attached to an article of clothing such as a pant pocket 126 or a shirt 128, respectively. To facilitate attaching the eyeglasses 100 to the article of clothing, the temples 108 of the eyeglasses 100 should sandwich the pant pocket 126 or edge of the shirt 128, as seen in the figures. Thus, when the magnets 114 on the temples 108 meet, the magnets 114 will exert a closing force against each other and through the article of clothing such that the eyeglasses will resist slipping out of the pocket 126 or shirt 128. Without the magnets 114, eyeglasses are generally susceptible to slipping out of a pant pocket or shirt as the wearer moves or bends over at the hips. With the eyeglasses 100 with the magnets 114 in the temples 108, the eyeglasses 100 are securely coupled or clipped to the article of clothing, thus, restraining the eyeglasses 100 from falling.

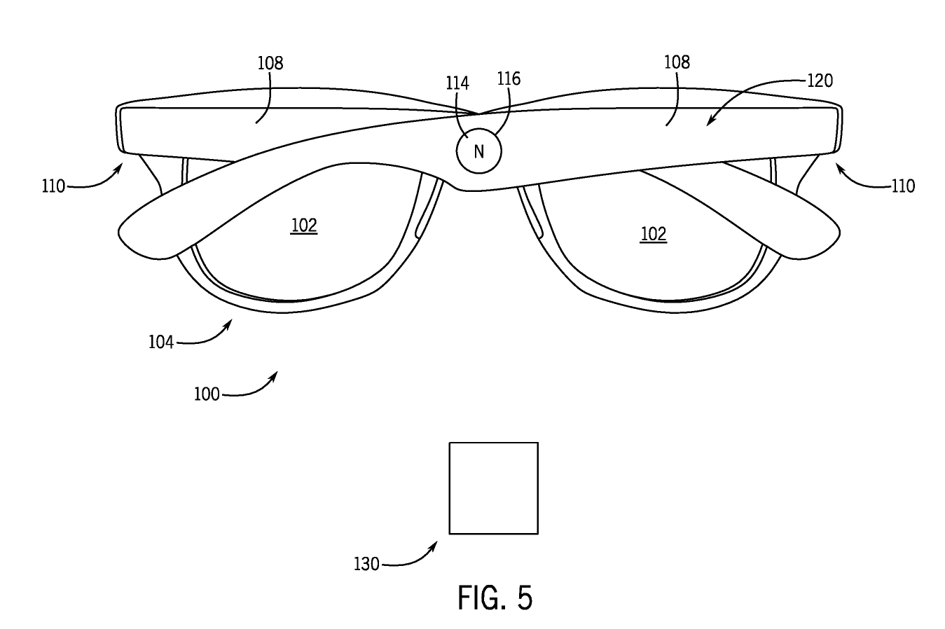

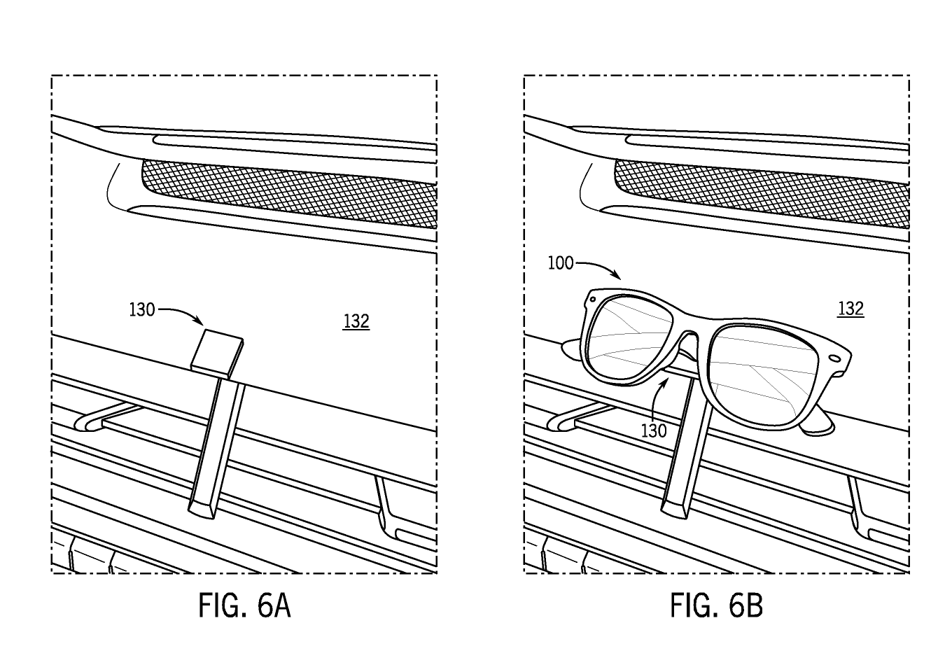

Reference is made to FIG. 5, which is a back view of the eyeglasses 100 with magnets 114 coupling the temples 108 together in a closed position, an attachment element 130 may be provided. The attachment element 130 may be a ferromagnetic material in any number of shapes. For example, the attachment element 130 may be square (as seen in FIG. 5), rectangular, circular, triangular, or any other shape such as the shape of a business/product logo. The attachment element 130 may include a fixation element (not shown) such as a double-sided adhesive pad on one side of the attachment element 130. In this way, the attachment element 130 may be secured to an object such as, for example, a dashboard 132 of a car via the fixation element (e.g., double-sided adhesive pad), as seen in FIG. 6A. And then, as seen in FIG. 6B, the eyeglasses 100 may be magnetically coupled with the attachment element 130 by bringing the magnet 114 on the temple 108 of the eyeglasses into contact with the attachment element 130.

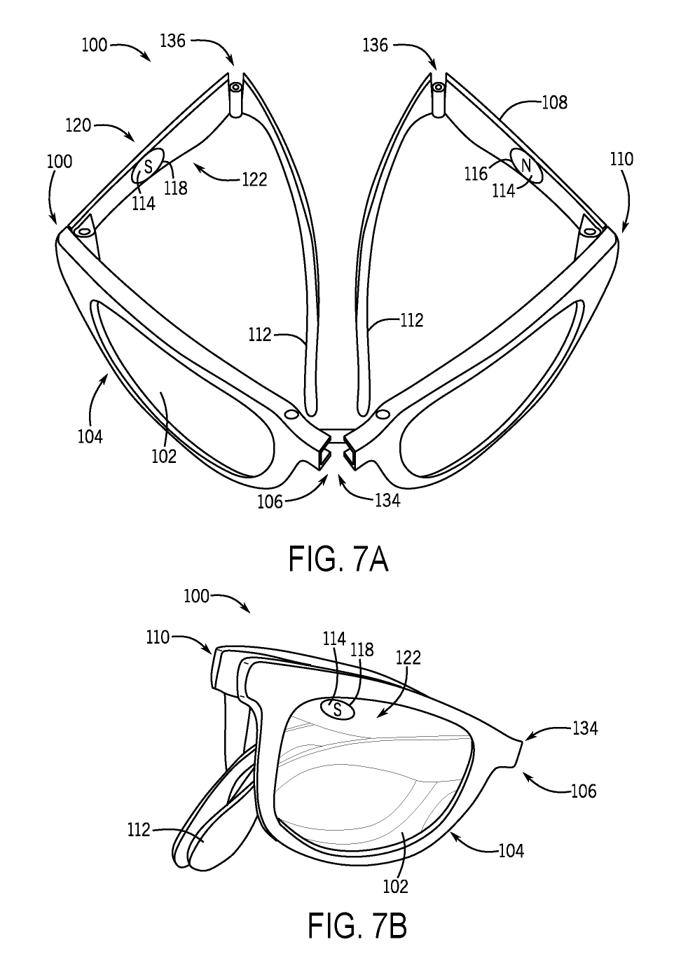

In certain embodiments, the magnets 114 may be positioned at different positions on the eyeglasses 100 depending on the particular design of the eyeglasses 100. Turning to FIG. 7A, which shows a pair of eyeglasses 100 with a bridge joint 134 at the bridge 106 and a joint 136 along each of the temples 108 between the hinge 110 and the earpiece 112, the magnets 114 may be positioned such that upon folding the eyeglasses at all joints 110, 134, 136, as seen in FIG. 7B, the magnets 114 will contact each other and hold the eyeglasses in the folded or closed position of FIG. 7B. The orientation of the magnets 114 in this particular embodiment may be such that a north pole 116 points outward from an outer surface 120 of one of the temples 108 and a south pole 118 points outward from an outer surface 120 of the opposite temple 108. In this way, upon folding the eyeglasses into the folded position of FIG. 7B, opposite poles will attract and hold the eyeglasses together in the folded position. In this arrangement, one of the magnets 114 may be replaced by a ferromagnetic material.

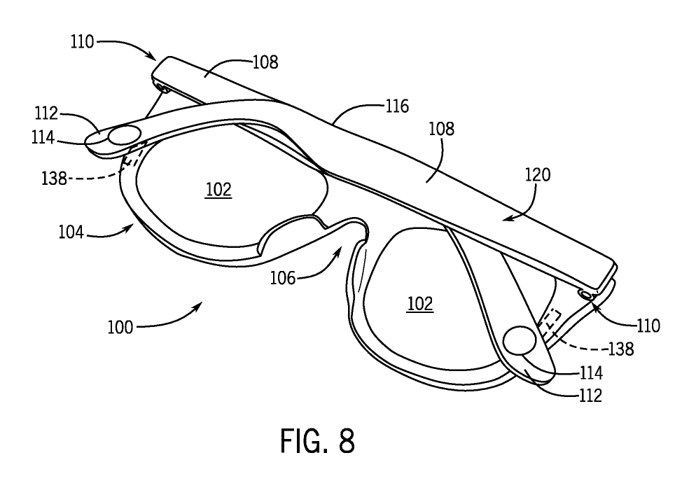

FIG. 8 shows another arrangement of magnets 114 on a pair of eyeglasses 100 where the magnets are positioned at the temple tip or earpiece 112 and a first and second ferromagnetic material 138 (e.g., steel, magnet) may be positioned on or within the frame 104 of the eyeglasses 100 on opposite sides of the frame 104. In this way, the earpieces 112 are magnetically attracted to the frame 104 at the outer ends of the eyeglasses 100. In this orientation, the magnet 114 may be positioned in any north-south arrangement since the magnet 114 is only contacting a ferromagnetic material and not another magnet 114. This is but one example of an alternative placement of the magnets 114 on the eyeglasses 100. Other locations and positions of the magnets 114 are contemplated and within the scope of the present disclosure.

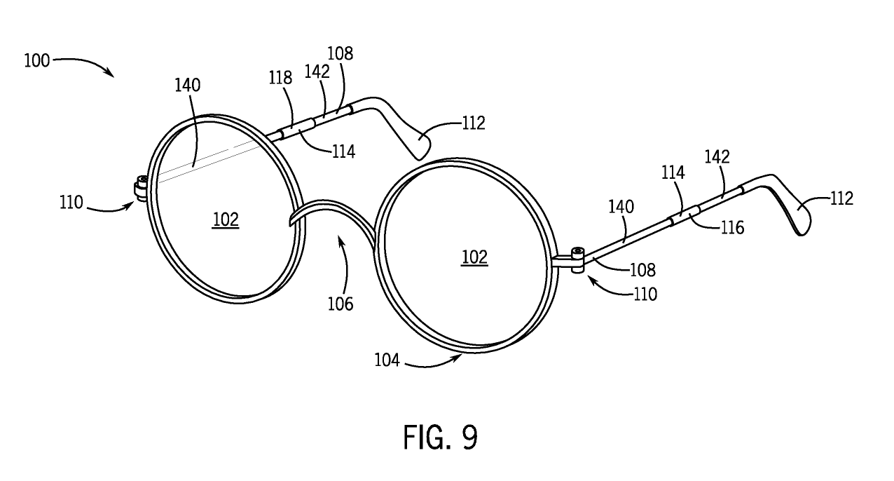

FIG. 9 shows a pair of wire frame glasses 100 with magnets 114 on the temples 108. In these types of glasses 100, the magnets 114 may be a structural part of the temple 108. That is, the magnet 114 may couple on opposite sides to a front and back section 140, 142 of the temple 108. In certain instances, the magnet 114 may be wrapped or slid around the wire frame of the glasses 100. In certain instances, the magnets 114 may be fitted within a slot or opening in the temples 108. In certain instances, the magnets 114 may be housed within the wire frame 104.

While the magnets 114 are shown as exposed or visible, it is foreseen that the magnets 114 may be recessed within pockets, channels, slots, or openings in the temples 108 of the eyeglasses 100 such that the magnets 114 are not visible, but are instead obscured by the eyeglasses 100 material. And while the magnets 114 are shown as being cylindrical, the magnets 114 may be other shapes including square, rectangular, or the like.

In certain embodiments, the magnets 114 may be removable from the eyeglasses 100. For example, as seen in FIG. 10, which is a side view of a temple 108 (outside or inside), a cylinder magnet 114 may be fitted within a cylindrical opening 144 in the temples 108 and then slid into a channel 146 within the temples 108. Once in the channels 146, the eyeglasses 100 would function as described in this application. The magnets 114 may, however, be removable by inserting a pin 148, for example, into an opening, pinhole, or slot 150 that extends into the channel 146. The slot 150 may be elongated with generally parallel sidewall portions. One end of the slot 150 may intersect the cylindrical opening 144. The magnet 114 may be forced back through the channel 146 with the pin 148 until the magnet 114 daylights in the cylindrical opening 144, where the magnet 114 may then be removed from the temples 108. As seen in FIG. 11, which is a cross-sectional view of the temple 108, the magnet 114 may be held in place within the channel 146 via a metal insert or biased tab 152 that depresses when the magnet 114 is inserted into the cylindrical opening 144, but then biases outward, thus preventing the magnet 114 from exiting, when the magnets 114 are moved to their final position within the channel 146.

In certain embodiments, the magnets 114 may be part of a fastener that is coupled to the temples 108. For example, as seen in FIG. 12, the magnet 114 may be part of a screw or bolt 154. In certain instances, the head 156 of the screw or bolt 154 may be a magnet 114. In certain instances, the shank 158 of the screw or bolt 154 may be a magnet 114. In this way, the screw or bolt 154 may be driven into the temple 108 of a pair of glasses 100 after manufacturing of the temples 108. Alternatively, the screws or bolts 154 may be manufactured into the temples 108; that is, the temples 108 may be molded around the screws or bolts 154.

As another example, as seen in FIG. 13, the magnet 114 may be part of a rivet 160. The rivet 160 may include a cap 162 and an eyelet 164 that are mechanically coupled together. The rivet 160 may be magnetized or coupled to the rivet 160, and the rivet may be pressed or secured to the temples 108 of the glasses 100.

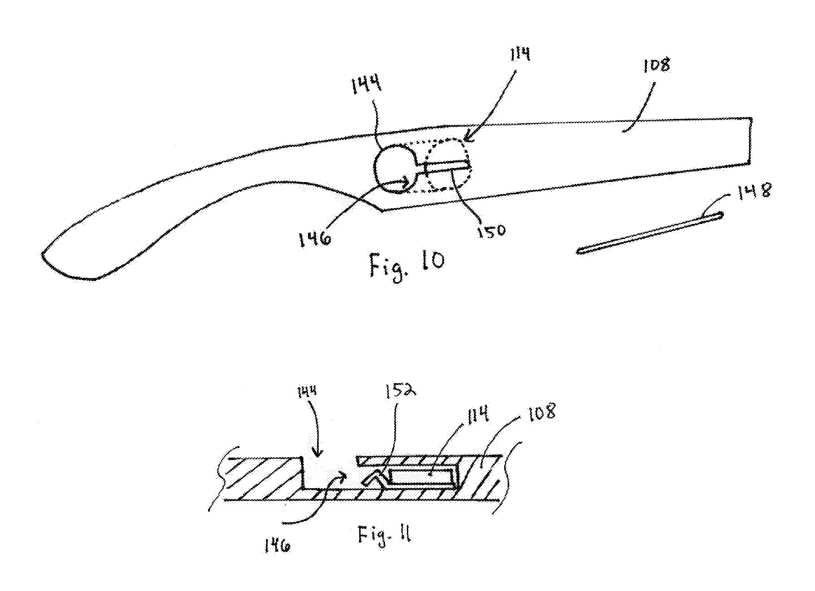

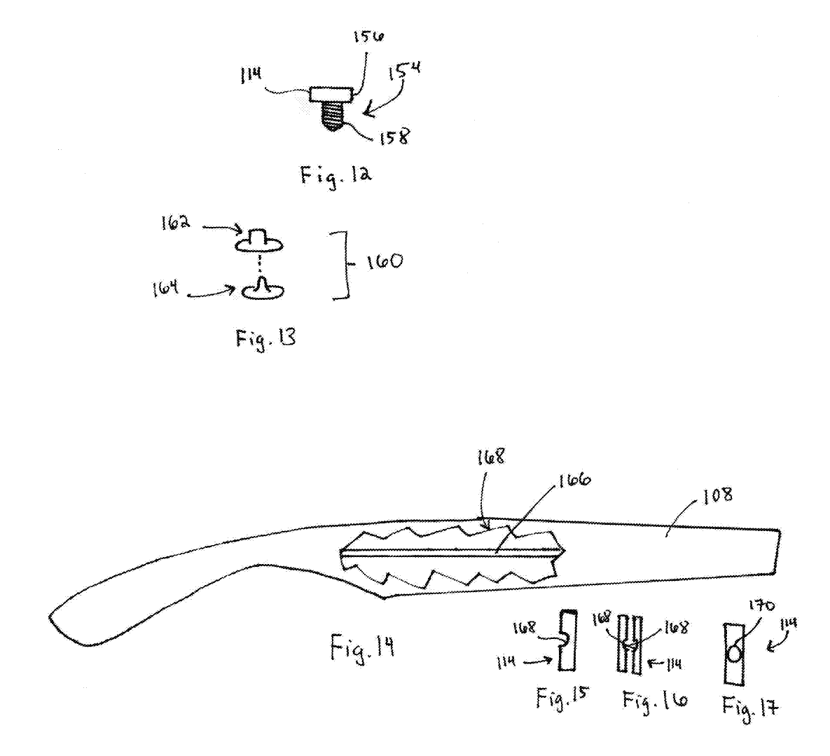

In certain instances, as seen in FIGS. 14-16, the magnets 114 may be held in position within the temples 108 by magnetically coupling to the metal inserts 166 that run the length of the temples 108 in certain eyeglasses 100. As seen in FIG. 14, which is a side view of a temple 108 with a cutout portion 168 to show the metal insert 166 therein, the metal insert 166 may be a rod that extends the length of the temple 108. In certain instances, a standard cylindrical magnet 114 may be positioned against or adjacent the metal insert 166. In certain instances, as seen in FIG. 15, the magnet 114 may include a semi-cylindrical indentation 168 so the magnet 114 may be positioned farther within the confines of the temple 108 such that the semi-cylindrical indentation 168 receives the metal insert 166 therein. In certain instances, as seen in FIG. 16, the magnet 114 may be two magnets 114, each with a semi-cylindrical indentation 168 therein such that the magnets 114 may sandwich the metal insert 114 such that the metal insert 166 is received within the confines of both semi-cylindrical indentations 168 of the magnets 114. In certain instances, as seen in FIG. 17, the magnet 114 may include a cylindrical passageway or bore 170 for the metal insert 166 to be received therein, for example, prior to molding of the temples. Additionally or alternatively, the magnets 114 may be positioned above or below the metal inserts 166. In certain instances, the metal inserts 166 themselves or a portion thereof may be manufactured from a magnetic material.

In certain embodiments, the temples 108 may be manufactured with the magnets 114 in position. In such an instance, the temples 108 may be injection molded, cast, or the like with the magnets 114 being over-molded. In certain instances, such as when the temples 108 are injection molded around the magnets 114, the magnets 114 may be fully covered by the injection molded material such that the magnets 114 are completely or partially obscured. In certain instances, a method of manufacturing an eyeglasses frame may include the steps of providing an eyeglasses frame mold, positioning a magnet 114 in one or both of the temple portion of the mold, injecting a molding material (e.g., PE, HDPE, ABS, POM, PC, PP, PET, TPE, PVC, etc.) into the mold, and removing the molded eyeglasses frames from the mold.

In certain instances, the logo on the outer side 120 of the temples 108 may be magnetized or include the magnets 114.

In certain embodiments, a sleeve may be outfitted with the magnet 114, and the sleeve may be slid onto the temples 108 of the eyeglasses 100. The sleeve may be slid up to an appropriate point on the temples 108 such that the magnets 114 will attract each other when the eyeglasses are folded. The sleeve may be part of a croakie or other eyewear retainer.

The magnets 114 as described herein may be of different strengths. In certain embodiments, the user may select a desired strength based on an activity level associated with the particular eyeglasses 100.

In certain instances, the eyeglasses 100 may be provided in a kit with the magnets 114. The kit may include an attachment element 130. While the application makes reference to “eyeglasses” the term is equally applicable to sunglasses, prescription glasses, or any other eyewear.

Although various representative embodiments have been described above with a certain degree of particularity, those skilled in the art could make numerous alterations to the disclosed embodiments without departing from the spirit or scope of the inventive subject matter set forth in the specification. All directional references (e.g., top, bottom, front, back) are only used for identification purposes to aid the reader's understanding of the embodiments of the present disclosure, and do not create limitations, particularly as to the position, orientation, or use of the embodiments unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure. It is intended that all matter contained in the above description or shown in the accompanying drawings shall be interpreted as illustrative only and not limiting. Changes in detail or structure may be made without departing from the spirit of the disclosure as defined in the appended claims.

What is claimed is:

1. An eyeglasses frame comprising:
a frame body for supporting a pair of lenses;
a first temple pivotally coupled with the frame body about a first hinge, the first temple terminating at a first earpiece unitarily formed with the first temple, the first temple comprising a first opening extending into a first width of the first temple, and a first channel extending lengthwise along the first temple away from the first opening, the first opening and the first channel both positioned between the first hinge and the first earpiece;
a second temple pivotally coupled with the frame body about a second hinge, the second temple terminating at a second earpiece unitarily formed with the second temple, the second temple comprising a second opening extending into a second width of the second temple, and a second channel extending lengthwise along the second temple away from the second opening, the first and second temples being formed from a non-metallic material, the second opening and the second channel both positioned between the second hinge and the second earpiece;
a first magnet configured to be removably positioned at least partially within the first channel of the first temple, the first temple being thicker than the first magnet; and
a second magnet configured to be removably positioned at least partially within the second channel of the second temple, the second temple being thicker than the second magnet,
wherein the first magnet and the second magnet are configured to be positioned adjacent each other and exert a closing force relative to each other when the first and second temples are pivoted, respectively, about the first and second hinges.

2. The eyeglasses frame of claim 1, wherein the first temple further comprises a first slot extending into the first channel from a first outer surface of the first temple, the first slot intersecting the first opening, and the second temple further comprises a second slot extending into the second channel from a second outer surface of the second temple, the second slot intersecting the second opening.

3. The eyeglasses frame of claim 2, further comprising a pin configured to be received within the first and second slots so as to remove the first and second magnets, respectively, from within the first and second channels.

4. The eyeglasses frame of claim 2, wherein the first temple further comprises a first biasing element positioned within the first channel and configured to securely support the first magnet within the first channel, and wherein the second temple further comprises a second biasing element positioned within the second channel and configured to securely support the second magnet within the second channel.

5. The eyeglasses frame of claim 4, wherein the first and second biasing elements each comprises a metal tab.

6. They eyeglasses frame of claim 1, wherein the first temple further comprises a first metal insert coupled with the first hinge and extending lengthwise within the first temple towards the first earpiece, the second temple further comprises a second metal insert coupled with the second hinge and extending lengthwise within the second temple towards the second earpiece, wherein the first magnet is configured to abut the first metal insert when positioned within the first channel, and wherein the second magnet is configured to abut the second metal insert when positioned within the second channel.

7. A kit comprising the eyeglasses frame and the pair of lenses of claim 5, further comprising an attraction element comprising a ferromagnetic material.

8. The kit of claim 7, wherein the attraction element comprises a shape of a company logo or product.

9. An eyeglasses frame comprising:
a frame body for supporting a pair of lenses;
a first temple pivotally coupled with the frame body about a first hinge, the first temple terminating at a first earpiece unitarily formed with the first temple, the first temple comprising a first insert coupled with the first hinge and extending lengthwise down at least a portion of the first temple towards the first earpiece;
a second temple pivotally coupled with the frame body about a second hinge, the second temple terminating at a second earpiece unitarily formed with the second temple, the second temple comprising a second insert coupled with the second hinge and extending lengthwise down at least a portion of the second temple towards the second earpiece, the first and second temples being formed from a non-metallic material;
a first magnet positioned within the first temple, the first magnet shaped and sized to avoid interference with the first insert, the first temple being thicker than the first magnet; and
a second magnet positioned within the second temple, the second magnet shaped and sized to avoid interference with the second insert, the second temple being thicker than the second magnet,
wherein the first magnet and the second magnet are configured to be positioned adjacent each other and exert a closing force relative to each other when the first and second temples are pivoted, respectively, about the first and second hinges.

10. The eyeglasses frame of claim 9, wherein the first magnet comprises a first semi-cylindrical indentation extending therethrough such that a first semi-cylindrical portion of the first insert is received therein, the second magnet comprises a second-semi-cylindrical indentation extending therethrough such that a second semi-cylindrical portion of the second insert is received therein.

11. The eyeglasses frame of claim 9, wherein the first magnet comprises a first cylindrical through hole extending therethrough such that a first cylindrical portion of the first insert is received through the first cylindrical through hole, the second magnet comprises a second cylindrical through hole extending therethrough such that a second cylindrical portion of the second insert is received through the second cylindrical through hole.

12. The eyeglasses frame of claim 9, wherein the first magnet is positioned above or below the first insert, and wherein the second magnet is positioned above or below the second insert.

13. The eyeglasses frame of claim 9, wherein the first magnet comprises a first pair of magnets that are positioned on opposite sides of the first insert so as to sandwich the first insert, and wherein the second magnet comprises a second pair of magnets that are positioned on opposite sides of the second insert so as to sandwich the second insert.

14. The eyeglasses frame of claim 13, wherein each of the first pair of magnets comprises a first semi-cylindrical indentation, and wherein each of the second pair of magnets comprises a second semi-cylindrical indentation.
